(19) United States
(12) Patent Application Publication
(10) Pub. No.: US 2002/0165775 A1
(43) Pub. Date: Nov. 7, 2002

(54) System and method for integrating offers

(75) Inventors: Per A. Tagseth, Phoenix, AZ (US); Nicole D. Coope, Gilbert, AZ (US); Geetanjali R. Suki, San Francisco, CA (US); Ray Preston, Peoria, AZ (US)

Correspondence Address: SNELL & WILMER, ONE ARIZONA CENTER, 400 EAST VAN BUREN, PHOENIX, AZ, 850040001

(73) Assignee: American Express Travel Related Services

(21) Appl. No.: 10/091,612

(22) Filed: Mar. 5, 2002

Related U.S. Application Data
(60) Provisional application No. 60/273,356, filed on Mar. 5, 2001.

(51) Int. Cl. G06F 17/60

(52) U.S. Cl. 705/14; 705/28

(57) ABSTRACT

The present invention is directed toward a system and method for administering incentive offers. A system for administering incentive offers includes a centralized repository 110 for storing offers, a maintenance engine 120 for updating and maintaining the offers in the repository 110, and a retrieval engine 130 for finding and retrieving offers. The system cooperates with an offer presentation engine 135 for configuring and presenting offers 160 based on offeree traits and the context in which the offer is to be presented. Each offer 160 may comprise both an offer summary 162 and offer details 164.

### CROSS REFERENCE TO RELATED APPLICATIONS

This application claims benefit from U.S. Provisional Patent Application Serial No. 60/273,356, filed Mar. 5, 2001, which is hereby incorporated by reference.

### FIELD OF INVENTION

The present invention relates generally to systems for administering incentives, and more specifically, to systems for facilitating the creation, storage, and retrieval of offers for presentation to consumers for the purpose of encouraging a desired set of one or more behaviors.

### BACKGROUND OF THE INVENTION

Institutions often communicate specialized incentives and other promotional offers to their existing and potential customers for the purpose of encouraging those customers to behave in a desired way. A wide variety of mechanisms are used by offerors to communicate specific offers to offerees or groups of offerees. For example, an offeror may present an off-line offer through telemarketing, direct mail, publications, advertising in the media, or communications at a point of sale. In addition, an offeror may present an on-line offer while interacting with an offeree through a computer network such as the internet.

In general, offers usually include a means through which an offeror may provide an incentive to an offeree such that, if a predetermined condition is satisfied, the offeree may enjoy the benefits associated with the incentive. While this general definition of an offer may be relatively simple, in practice, there are many variables which may be combined to render a nearly limitless array of specific offers. Thus, although the content of the offers may vary widely, the basic characteristics of offers remain fairly consistent.

For example, the incentives embodied in a specific offer may be tangible or intangible in nature. If the incentive is a tangible object, the offer may be structured so that the offeree may receive possession of the object. If the incentive is intangible, such as a right to receive a discount, to use information, or to enjoy some other benefit, the offer may be structured so that the offeree will be entitled to enjoy that intangible incentive.

In addition to the nature of the incentive, offers may vary in the form of their predetermined conditions. For example, an offeror may wish to condition the incentive upon the purchase or use of a specific good or service. Alternatively, the offeror may tie the incentive to an action taken at a specific merchant or service provider. Further, an offeror may wish to provide an incentive to encourage a series of behaviors such as making consistent timely payments, demonstrating loyalty to a particular merchant, maintaining a specified minimum or maximum monthly balance in an account, or transacting a desired quantity of business using a specified charge or credit card. While these predetermined conditions may vary widely, they consistently involve a definition of who (e.g., the target consumer) should perform what act (e.g., use or agree to purchase specific goods or services) within what time period (e.g., during the offer period) and at what location (e.g., at a specified merchant).

In some cases, it is a single specific entity within a company, such as the marketing organization, that is responsible for managing the definition, communication, and administration of offers. Although such organizations may delegate some or all of the tasks relating to managing offers, they may still retain significant controls. It has been found that such centralized management of offers enables coordination between the participants in the process and adequate control over the creation and presentation of offers, which can contribute to consistency between communicated offers, enhancing the effectiveness of those offers in modifying offeree behavior.

In other organizations, particularly in large, geographically diverse organizations, it is often the case that no single entity is responsible for all aspects of managing the definition, communication, and administration of offers. As a result, the same or similar offers may be created multiple times by multiple organizations or business units, with different, and often conflicting or competing, objectives in mind. Wherever little or no centralized body exists to manage offers, there frequently will be little or no coordination or control governing their creation and presentation. Consequently, inconsistent offers may be presented, causing offeree experiences that may be unbalanced, inconsistent and confusing. As a result, the incentive programs may be counterproductive and may be unable to achieve their desired objectives.

The recent growth in on-line commerce, in which many large organizations now participate, has partially ameliorated these shortcomings. In the on-line environment, organizations are able to speak with a single voice, no matter how geographically diverse the organization may be. As a result, on-line commerce offers new opportunities to avoid inconsistencies in the presentation of offers. For example, the opportunity now exists to collectively manage offers from multiple diverse merchants as well as offers from discrete large entities.

At the same time, however, it is not always preferable to provide only a single offer to all offerees in all situations. Whether offers are to be collected and centrally managed for a single, large organization or for many small, diverse merchants, consideration must be given to the regulatory, environmental, taxation, competitive, and environmental variations that exist throughout the global marketplace. The incentives used to encourage offerees to behave in a desired manner may depend upon income level, gender, ethnicity, past behavior, or other offeree traits. They may also depend the context of the offer such as geographic location, the current economic climate, laws and regulations, or seasonal variations in the marketplace. Under a system of distributed discretion, individuals within the system may be better able to tailor specific offers to specific offerees and specific situations, enhancing the effectiveness of each of the offers. Accordingly, while a centralized offer management infrastructure may facilitate consistency between offers, such an infrastructure may be ineffective if it fails to effectively accommodate variations in the traits of its intended offerees and the context in which the offer is to be presented. The centralized management of offers may actually be counterproductive if the system is unable to accommodate the wide array of variables that exist in the marketplace.

Accordingly, it would be beneficial to have a system and method for providing centralized management of offers while enabling offers to be customized for specific offerees and situations.

### SUMMARY OF THE INVENTION

The present invention is directed toward a system and method for administering incentive offers. In particular, the invention is directed toward a system and method for facilitating the creation, storage, maintenance, identification, and retrieval, of incentive offers for presentation to offerees for the purpose of encouraging a desired set of one or more behaviors. A system for administering incentive offers includes a centralized repository for storing offers, a maintenance engine for updating and maintaining the offers in the repository, and a retrieval engine for finding and retrieving offers. The system cooperates with an offer presentation engine for configuring and presenting offers based on offeree traits and the context in which the offer is to be presented. Each offer may comprise both an offer summary and offer details.

A centralized repository is configured to store an offer summary and a set of offer details for each stored offer. In general, offer details include who (e.g., the target consumer) must perform what act (e.g., use or agree to purchase specific goods or services) within what time (e.g., during the offer period) and at what location (e.g., at a specified merchant) in order to receive what incentive. A maintenance engine is adapted to respond to requests to create, modify, and delete offer summaries and offer details stored within the centralized offer repository. A maintenance engine also includes a security mechanism adapted to authenticate a user before granting the user access to the repository. In accordance with an exemplary embodiment, a security mechanism is configured to limit access to a specific user or group of users, thereby enabling a maintenance engine to safeguard the confidentiality of data within the repository and to prevent data from being disclosed in any unauthorized or undesirable manner. Finally, a retrieval engine includes both a search tool and a retrieval tool and is configured to cooperate with an offer presentation engine for configuring and presenting offers. Accordingly, a retrieval engine is adapted to send a request to the search tool for the identification of an offer or set of offers. The search tool is configured to identify conforming offers, and the retrieval tool is configured to retrieve the identified offer or set of offers. Finally, the system is configured to facilitate the configuring and presenting of an offer to an offeree by the offer presentation engine.

### BRIEF DESCRIPTION OF EXEMPLARY DRAWINGS

The above-mentioned objects and features of the present invention can be more clearly understood from the following detailed description considered in conjunction with the following drawings, in which like numerals represent like elements and in which:

FIG. 1 illustrates an exemplary system for administering incentive offers;

FIG. 2 illustrates an exemplary centralized offer repository; and

FIG. 3 illustrates an exemplary process for administering incentive offers.

### DETAILED DESCRIPTION OF EXEMPLARY EMBODIMENTS

The present invention includes an incentive offer storage and retrieval vehicle that is configured to allow users to administer incentive offers in a coordinated and consistent manner. The system thereby facilitates the creation, storage, maintenance, identification, and retrieval, of incentive offers for presentation to offerees for the purpose of encouraging a desired set of one or more behaviors. In accordance with one aspect of the invention, a system for administering incentive offers includes a centralized repository for storing offers, a maintenance engine for updating and maintaining the offers in the repository, and a retrieval engine for finding and retrieving offers. In an exemplary embodiment, the system may be configured to facilitate the configuring and presenting of an offer to an offeree by an offer presentation engine.

Each offer may comprise both an offer summary and offer details. A centralized repository is configured to store an offer summary and a set of offer details for each stored offer. In general, offer details define who (e.g., the target consumer) must perform what act (e.g., use or agree to purchase specific goods or services) within what time (e.g., during the offer period) and at what location (e.g., at a specified merchant) in order to receive what incentive.

A maintenance engine is in communication with the centralized repository and is adapted to facilitate the creation, modification, and deletion of offer summaries and offer details stored within the centralized offer repository. I should be noted that as soon as an offer has been added to the repository and approved by the merchant, it may be available to be searched and/or retrieved. A maintenance engine also includes a security mechanism adapted to facilitate the authentication of a user before granting the user access to the repository or otherwise facilitating manipulation of offer data by the user. In accordance with an exemplary embodiment, a security mechanism is configured to limit access to a specific user or group of users, thereby enabling a maintenance engine to safeguard the confidentiality of data within the repository and to prevent or limit data from being disclosed in any unauthorized or undesirable manner.

Further, a retrieval engine is also in communication with the centralized database and includes both a search tool and a retrieval tool. Accordingly, a retrieval engine is adapted to send a request to the search tool for the identification of an offer or set of offers. The search tool is configured to identify conforming offers, and the retrieval tool is configured to retrieve the identified offer or set of offers for communication to an offer presentation engine. In an exemplary embodiment, the search and retrieval instructions may be configured by a user. Thus, in response to a user defined request, which may include definitions of which offer parameters are to be sought and which parameters are to be retrieved, the retrieval engine seeks the desired offers in accordance with the user selected parameters and returns the parameters desired by the user. It should be noted that the user specification of offer parameters to be returned may be expressed as an instruction to return only a specified set of parameters or alternatively may be expressed as an instruction to return at least a specified set of parameters or may be expressed in any other form commonly known in the art.

Accordingly, the retrieval engine is configured to communicate with an offer presentation engine, which facilitates the configuring and presenting of an offer to an offeree. Upon receipt of the requested offer information, an offer presentation engine facilitates the configuring of offers, accommodating variations in the traits of offerees and the contexts in which the offers are to be presented. Accordingly, the system may be configured to accommodate many variables that exist in the marketplace.

In accordance with a further aspect of the present invention, a method of administering an incentive offer storage and retrieval vehicle is also provided. In accordance with the invention, an administrator may receive a request from a user to create, modify or delete an offer or a portion of an offer. In response, the administrator causes the maintenance engine to perform a database maintenance process. In an exemplary embodiment of the database maintenance process, the maintenance engine causes a security mechanism to authenticate the user, e.g., determining whether the user is authorized to initiate the action or whether the action is desirable to the system in accordance with a predetermined set of rules (i.e., that offer data be modified only by the offering merchant, that offer data be retrievable by anyone, that specific search queries be accessed by only authorized members). If the security mechanism authenticates the user and approves the desired action, the maintenance engine accommodates the user's request and modifies the offer data accordingly. In this way, the maintenance engine facilitates the maintenance of the centralized repository of offer data.

In accordance with the invention, the administrator may also receive a request from a user seeking to find offers bearing specified characteristics (e.g., offers for a specified service to be performed in a specified location or by a specified service provider, offers pertaining to a specific product, a particular offer identified by a reference code or SKU information). In response to the user's request, the administrator initiates an action by the retrieval engine, which responds by activating its search tool to identify offers bearing the desired characteristics. Once the search tool has identified the conforming offers, the retrieval engine activates its retrieval tool, which retrieves the conforming offer data.

Upon receipt of the offer data from the retrieval tool, the retrieval engine is configured to facilitate the configuring and presenting of an offer to an offeree by an offer presentation engine, which is in communication with the retrieval tool. The presentation engine facilitates the configuring of offers based on the traits of offerees and the contexts in which the offer is to be presented to the offerees. For example, if a particular offeree has demonstrated a certain level of creditworthiness, the presentation engine may configure an offer for a credit card to have a lowered interest rate in accordance with a set of rules accompanying the offer details. As a further example, the presentation engine may configure an offer for a discount on the purchase of a perishable item with the discount being based on the date of the offer relative to the expiration date of the available stock of the item or the quantity of the item remaining. Accordingly, the presentation engine may configure an offer for presentation to an offeree based on the traits of the offeree and the context in which the offer is to be presented. As such, the presentation engine may be configured to create, adapt and/or modify the offers in accordance with a predetermined set of rules as well as other required data regarding either the offeree or the contextual environment of the offer. Accordingly, the offer as presented by the retrieval engine may not include all of the information in the offer details, but instead, may represent a customized presentation adapted to the particular offeree or the particular situation. Thus, in accordance with the present invention, the system may encourage customers to accept more offers.

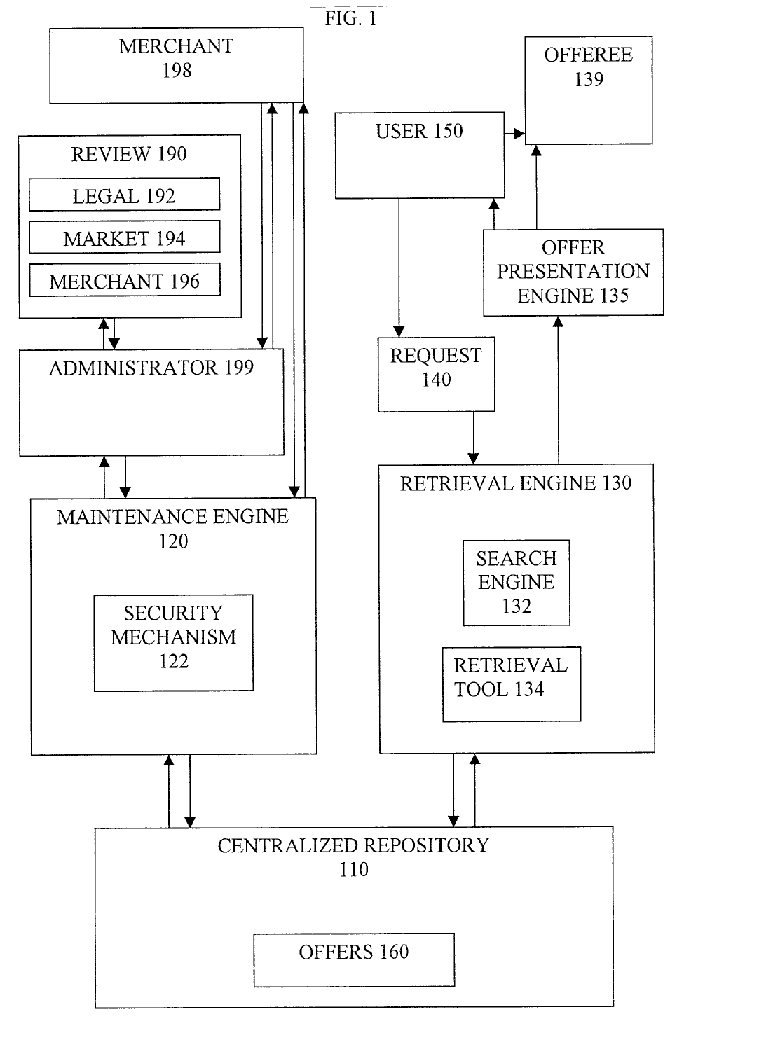

More particularly, FIG. 1 illustrates an exemplary system configured to administer an incentive offers utility. In accordance with an exemplary embodiment, the system includes a centralized repository 110 that is configured to store offers 160. The centralized repository 110 is in communication with a maintenance engine 120 that is configured to facilitate the updating and maintaining of offers 160 within the repository 110. In addition, the maintenance engine 120 is in communication with both an administrator 199 and a merchant 198. Upon agreement between the merchant 198 and the administrator 199 regarding the content of an offer 160, the administrator 199 cooperates with the maintenance engine 120 to accomplish the addition, modification, and/or deletion of an offer 160 within the repository 110. The maintenance engine 120 is configured to facilitate the addition, modification, and deletion of offers 160 based on instructions from the administrator 199. The maintenance engine 120 is also configured to facilitate the merchant's 198 directly searching and viewing offers 160 in the repository 110.

The repository 110 is also in communication with a retrieval engine 130 that is configured to facilitate the finding and retrieving of offers 160. The retrieval engine 130 is also in communication with an offer presentation engine 135 that is configured to facilitate the configuring and presenting of an offer to an offeree 139. The retrieval engine 130 is in communication with a user 150 and is configured to receive a request 140 from the user 150 for the retrieval of conforming offers 160. The request 140 may comprise search and retrieval instructions that may be configured by the user 150. It should be noted that the request 140 may include definitions of which offer parameters are to be sought and which parameters are to be retrieved. In response to the request 140, the retrieval engine 130 seeks the desired offers 160 via the user selected parameters and returns the parameters desired by the user. As discussed above, the user specification of offer parameters to be returned may be expressed as an instruction to return only a specified set of parameters or alternatively may be expressed as an instruction to return at least a specified set of parameters or may be expressed in any other form commonly known in the art. It should be noted that the user 150 may or may not be the offeree 139. In the event that the user 150 is not the offeree, the user 150 may present the offer to the offeree 139 or alternatively, the offer presentation engine 135 may present the offer directly to the offeree 139.

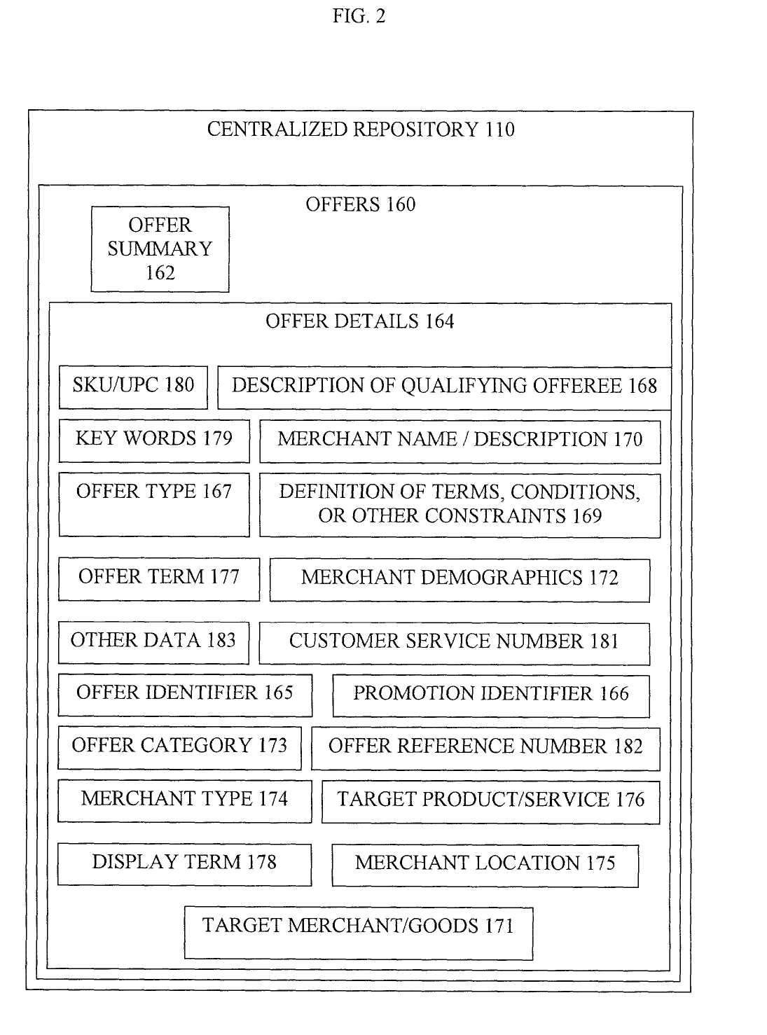

FIG. 2 illustrates an exemplary centralized repository 110. Each of the offers 160 in the repository 110 may include an offer summary 162 and a set of offer details 164. The repository or database 110 may be any type of database, such as relational, hierarchical, object-oriented, and/or the like. Common database products that may be used to implement the databases include DB2 by IBM (White Plains, N.Y.), any of the database products available from Oracle Corporation (Redwood Shores, Calif.), Microsoft Access by Microsoft Corporation (Redmond, Wash.), or any other database product. The repository 110 may be organized in any suitable manner, including as data tables or lookup tables. Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in each of the manufacturer and retailer data tables. A “key field” partitions the database 110 according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

The system, which may be embodied in the form of a computer system, may provide a suitable website or other Internet-based graphical user interface which is accessible by users. In one embodiment, the Internet Information Server, Microsoft Transaction Server, and Microsoft SQL Server, are used in conjunction with the Microsoft operating system, Microsoft NT web server software, a Microsoft SQL database system, and a Microsoft Commerce Server. Additionally, components such as Access Sequel Server, Oracle, MySQL, Intervase, etc., may be used to provide an ADO-compliant database management system. The term “webpage” as it is used herein is not meant to limit the type of documents and applications that might be used to interact with the user. For example, a typical website might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like.

In general, the offer details 164 define who (e.g., the target consumer) must perform what act (e.g., use or agree to purchase specific goods or services) within what time (e.g., during the offer period) and at what location (e.g., at a specified merchant) in order to receive what incentive. Specifically, offer details 164 may include an offer identifier 165, an offer promotion identifier 166 (e.g., identification of a specific marketing campaign or promotion), an offer type 167 (e.g., the method of presentation, fulfillment, or redemption), a description of qualifying offerees 168, and definitions of terms, conditions or other constraints 169. Additional details may include a merchant name and/or description 170, trademarks and/or service marks relating to the target merchant or the target goods 171, merchant demographics 172 (e.g., name, address, telephone number, facsimile number, internet address, email address), offer category 173 (e.g., industry, retail, dining, shopping), offer subcategory (e.g., product, merchant), merchant type 174 (e.g., single-location, chain), geographic location 175 (e.g., country, region, state, city, neighborhood, longitude, latitude, intersection, street address, zip code), target product or service 176, offers term 177 (e.g., start date/time, end date/time), display term 178 (e.g., display start date/time, display end date/time), key word(s) 179, SKU/UPC information 180, customer service telephone number 181, and an offer reference number 182. The offer details may further include any other data that would be helpful in identifying and characterizing offers to be sought by an offeror or an offeree and to be presented to that offeree 183.

The system is a dynamically searchable offer database 110 directly maintained by business partners 198 and accessible by clients 150. The database 110 includes data for online offers 160, such as its descriptive attributes 164 as well as the rules as to how the offer is to be managed and used. This representation is generic, because in one embodiment, there is nothing stored as to how the offer 160 will be used by the different application/business unit. This separation of content (the offer) 160 and context (how it will be used by some application) allows the offers 160 to be simplified and enables the platform to be integrated and standardized. This approach also allows the platform to be extended outside the entity, by enabling external third parties to use the database to house their own offers or as a source for displaying an individual entity's offers on its own web-sites.

In an exemplary embodiment, the database 110 is managed using a single application using either online and/or batch based processing. The process supports the key functions to add, change, and delete data for offers 160 or some discrete piece of an offer 160. Additionally, the process implements a workflow capability that allows customizable processes to be overlaid onto offers 160 for controlling how the offer 160 is created, refined, authorized, approved and published for use by consuming applications such as an offer presentation engine 135.

More specifically, in one embodiment, the offers 160 comprise a collection of attributes 164 detailing the content and make-up of each offer 160, an associated set of rules that identifies how and when the offer can/cannot be used 164, and a workflow that defines the process by which the offer must follow before it can be made available to an offeree. The context to be applied for the online offer is provided by the online process that will be requesting and accessing the offer data 160 from the system. In an exemplary embodiment, the data 160 is housed in a standard, consolidated and integrated database 110 that can be accessed by any approved user, including external third parties. The exemplary platform is designed to be process oriented instead of data (offer) oriented, thus making it open as to how it supports the corresponding process (beginning to end) and the data for each offer. This allows the offer 160 to be open in its definition and use, allowing an offer 160 to be used narrowly or very broadly.

In one embodiment, the platform may not provide presentation capabilities 135 for these online offers 160, so the data 160 is made available to requesters through a set of interfaces (API's). This interface describes how data must be requested (including searches and their corresponding variables) and how the results will be returned (using “databaskets”). One of the features included in how the data 160 can be requested is a search function. This search is performed dynamically based on one or more variables that may be defined 140 by the user 150. These online offers can be accessed by anyone with access to the database, including internal functions or those hosted by external third parties.

In an exemplary embodiment, the maintenance engine 120 is adapted to cooperate with an administrator 199 to create, modify, and delete offer summaries and offer details stored within the centralized offer repository 110. The maintenance engine 120 is also adapted to provide a security mechanism 122 adapted to authenticate a merchant 198 and/or administrator 199 before granting access to either. Accordingly, the security mechanism 122 is configured to limit access to a specific party or group of parties. Accordingly, the security mechanism 122 enables the maintenance engine 120 to safeguard the confidentiality of data 160 within the repository 110, preventing data 160 from being disclosed in an unauthorized or undesirable manner. The maintenance engine 120 is also configured to administer the review and approval of new offers 160 or offer modifications through various reviewing entities 190. In an alternative embodiment, the review may be administered by the administrator 199. These reviewing entities 190 may include one or more legal administrators 192, one or more marketing administrators 194, one or more designated merchants 196, and the like. Also, the maintenance engine 120 is configured to track the number of times a particular offer 160 or class of offers has been retrieved or requested. In addition, the maintenance engine 120 may be configured to export reports in accordance with a predetermined set of criteria (e.g., the occurrence of a predetermined event, such as the passage of a date).

The retrieval engine 130 is configured for retrieving offers 160 and may include both a search tool 132 and a retrieval tool 134. The retrieval engine 130 is adapted to send a request to the search tool 132 for the identification of an offer or set of offers 160. The retrieval tool 134 is configured to retrieve the identified offer or set of offers 160 for presentation to the offeree by the retrieval engine 130. The search tool 132 provides the ability for users 150 to search for offers 160 using multiple search criteria (i.e., category, type, industry, etc.) within all elements of the database 110 that are deemed as searchable. Upon receipt of the request 140, the search tool 132 searches for the requested offer 160 and the retrieval tool 134 retrieves the summaries 162 and details 164 of the requested offer or offers 160. In an exemplary embodiment, the retrieval engine 130 is configured to generate additional reports 138 describing offers contained within the repository or the number of times an offer has been retrieved. Finally, the retrieval engine 130 may be configured to describe how data is retrieved or presented, and may also be configured to perform a search function responsive to several variables.

The presentation engine 135, which is in communication with the retrieval engine 130, facilitates the configuring and presenting of an offer 160 to an offeree, e.g., via a webpage. The presentation engine 135 receives data regarding an offer 160 from the retrieval tool 134 and also may receive data regarding the traits of the offeree and/or the context in which the offer is to be presented. Based on that information, or based on a predefined set of defaults if context or trait information is not available, the presentation engine 135 facilitates the configuring of the offer 160 based on the traits of offerees and the contexts in which the offer is to be presented.

The system contemplates the use of a well-defined interface, making the database 110 and maintenance function 120 accessible to anyone interested in presenting online offer data 160 to users. Consolidated processes and infrastructure supporting various online offers will reduce the resources and costs needed to create and maintain offers 160, while enabling the enterprise strategy of a single integrated online offers database that can be used with a company website. The system may also streamline the offeree experience by eliminating confusion that offerees experience today in viewing various online offers contained on a host website, positioning the company website as a destination site that provides continuous and ongoing value to offerees and driving increased on-line spending. The system also streamlines business processes across the enterprise for online offers by consolidating offeree communications by directing them to a single online offer source, establishing consistent branding of online offers across the company's applications and eliminating merchant confusion as individual online offer programs are sold-in to merchants with distinct/unique pricing implications and features. The system will also enable more offers 160 to be created and exposed to the consuming public.

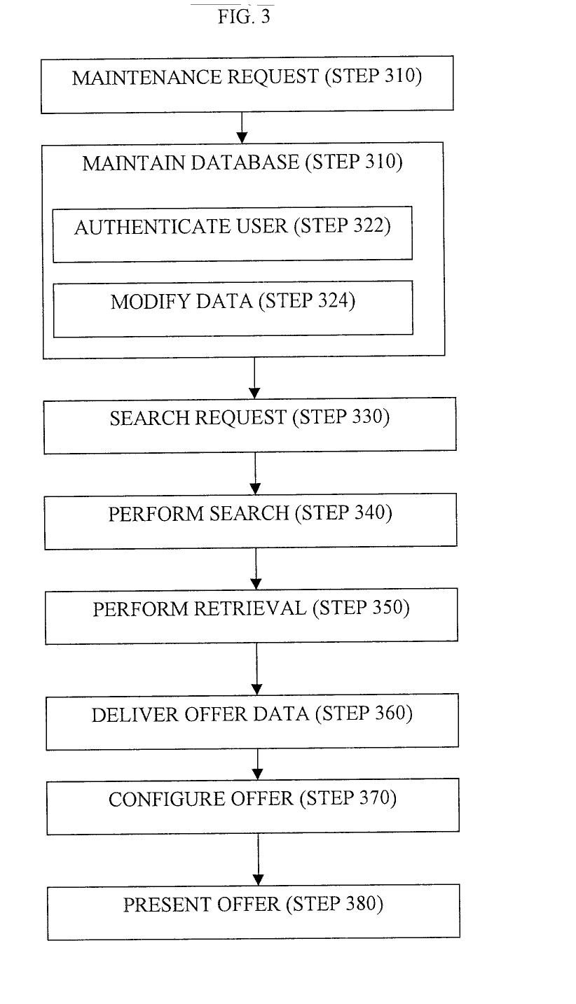

FIG. 3 depicts an exemplary method of administering an incentive offer storage and retrieval process. In accordance with the invention, a merchant 198 communicates a request to an administrator 199 to create, modify or delete an offer 160 or a portion of an offer (step 310). In an exemplary embodiment, the administrator 199 and the merchant 198 may negotiate and reach agreement on the content of the offer 160 to be implemented. In response, the administrator 199 causes the maintenance engine 120 to perform a database maintenance process (step 320). In an exemplary embodiment of the database maintenance process (step 320), the maintenance engine 120 causes a security mechanism 122 to authenticate the user, e.g., determining whether the user is authorized to initiate the action or whether the action is desirable to the system in accordance with a predetermined set of rules (step 322). If the security mechanism 122 authenticates the user and approves the desired action, the maintenance engine 120 accommodates the user's request and modifies the offer data accordingly (step 324). Once an offer 160 has been approved and implemented in the repository 110, it is available for review by the merchant 198. Accordingly, the maintenance engine 120 maintains the centralized repository of offer data 160, which comprises offer summaries 162 and offer details 164.

In accordance with the invention, a user 150 may also communicate a request 140 to the retrieval engine 130 seeking offers 160 bearing specified characteristics (e.g., offers for a specified service to be performed in a specified location or by a specified service provider) (step 330). In response to the user's 150 request 140, the retrieval engine 130 responds by activating its search tool 132 to retrieve offers bearing the desired characteristics (step 340). Once the search tool 132 has identified the conforming offers, the retrieval engine 130 activates its retrieval tool 134, which retrieves the conforming offer data 160, which may include offer summaries 162 and offer details 164 (step 350). Upon retrieval of the offer data 160, the retrieval engine 130 may communicate the offer data 160 to an offer presentation engine 135 or may deliver the information to an interface (API) (step 360). Upon receipt of the offer data 160 from the retrieval tool 134, the offer presentation engine 135 may configure the offer in accordance with rules imbedded in the offer 160 as well as offeree traits and the offer context or appropriate defaults (step 370). Finally, the offer presentation engine 135 presents the configured offer to the user 150, who may be an intended offeree or who may be a merchant interfacing with the intended offeree (step 380).

The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, or the like, with the various algorithms being implemented with any combination of data structures, objects, processes, routines or other programming elements. Further, it should be noted that the present invention may employ any number of conventional techniques for data transmission, signaling, data processing, network control, and the like. For a basic introduction of cryptography, please review a text written by Bruce Schneier which is entitled “Applied Cryptography: Protocols, Algorithms, And Source Code In C,” published by John Wiley & Sons (second edition, 1996). Other useful references include Gilbert Held's “Understanding Data Communications” (1996), Dilip Naik's “Internet standards and Protocols” (1998), and “Java 2 Complete” published by Sybex (1999).

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

It will be appreciated, that many applications of the present invention could be formulated. One skilled in the art will appreciate that the network may include any system for exchanging data or transacting business, such as the Internet, an intranet, an extranet, WAN, LAN, satellite communications, and/or the like. The users may interact with the system via any input device such as a keyboard, mouse, kiosk, personal digital assistant, handheld computer (e.g., Palm Pilot®), cellular phone and/or the like. Similarly, the invention could be used in conjunction with any type of personal computer, network computer, workstation, minicomputer, mainframe, or the like running any operating system such as any version of Windows, Windows NT, Windows2000, Windows 98, Windows 95, MacOS, OS/2, BeOS, Linux, UNIX, or the like. Moreover, although the invention is frequently described herein as being implemented with TCP/IP communications protocols, it will be readily understood that the invention could also be implemented using IPX, Appletalk, IP-6, NetBIOS, OSI or any number of existing or future protocols. Moreover, the system contemplates the use, sale or distribution of any goods, services or information over any network having similar functionality described herein.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Communication between the parties to the system of the present invention is accomplished through any suitable communication means, such as, for example, a telephone network, Intranet, Internet, point of interaction device (point of sale device, personal digital assistant, cellular phone, kiosk, etc.), online communications, off-line communications, wireless communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The present invention is described herein with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

The merchant, administrator, user, offeree and any other participant may represent individual people, entities, computers, systems, or business. Although labeled as a merchant or company, the entity may represent other types of institutions, such as credit card companies, card sponsoring companies, banks, or third party issuers under contract with financial institutions. It is further noted that other participants may be involved in some phases of the transaction, such as an intermediary settlement institution, but these participants are not shown.

Each participant is equipped with a computing system to facilitate online communication. The parties may have a computing unit in the form of a personal computer, although other types of computing units may be used including laptops, notebooks, hand held computers, set-top boxes, and the like. The parties may also have a computing unit implemented in the form of a computer-server, main frame computer, mini-computer, a PC server, a network set of computers, although other implementations are possible.

The computing units are connected with each other via a data communication network. The network is a public network and assumed to be insecure and open to eavesdroppers. In the illustrated implementation, the network is embodied as the internet. In this context, the computers may or may not be connected to the internet at all times. For instance, some of the computers may employ a modem to occasionally connect to the internet, whereas other computers might maintain a permanent connection to the internet. It is noted that the network may be implemented as other types of networks, such as an interactive television (ITV) network.

What is claimed is:

1. A system for administering incentive offers comprising:
a centralized repository 110,
a maintenance engine 120 in communication with the centralized repository for facilitating the maintenance of the repository 110,
and a retrieval engine 130 in communication with the centralized repository 110 for facilitating the identification and retrieval of an offer 160,
said centralized repository 110 being configured to store a plurality of offers 160.

2. A system as in claim 1, said maintenance engine 120 being adapted to cooperate with an administrator 199 to create, modify, or delete an offer 160 stored within the centralized repository 110.

3. A system as in claim 1, said maintenance engine 120 being further adapted to provide a security mechanism 122 to authenticate a merchant 198 before granting access to the merchant 198.

4. A system as in claim 3, said security mechanism 122 being configured to limit access to a specific merchant or group of merchants 198 whereby the security mechanism 122 enables the maintenance engine 120 to safeguard the confidentiality of data 160 within the repository, preventing data 160 from being disclosed in an unauthorized or undesirable manner.

5. A system as in claim 2, said system being configured to facilitate review and approval of new offers 160 through one or more reviewing entity 190.

6. A system as in claim 5, said reviewing entity 190 including one or more legal administrator 192.

7. A system as in claim 5, said reviewing entity 190 including one or more marketing administrator 194.

8. A system as in claim 5, said reviewing entity 190 including one or more designated merchant 196.

9. A system as in claim 1, said maintenance engine 120 being configured to facilitate tracking of times a particular offer 160 has been sought or retrieved.

10. A system as in claim 1, said maintenance engine 120 being configured to facilitate tracking of times a particular class of offers has been sought or retrieved.

11. A system as in claim 1, said maintenance engine 120 being configured to facilitate export of a report in accordance with a predetermined set of criteria.

12. A system as in claim 1, said retrieval engine 130 being configured to facilitate presenting of offers 160 via a webpage.

13. A system as in claim 1, said retrieval engine 130 including a search tool 132.

14. A system as in claim 13, said search tool 132 being configured to facilitate identification of an offer or set of offers 160 in accordance with specified search criteria.

15. A system as in claim 13, said search tool 132 configured to facilitate identification of an offer or set of offers 160 in accordance with multiple search criteria.

16. A system as in claim 1, said retrieval engine 130 including a retrieval tool 134.

17. A system as in claim 16, said retrieval tool 134 being configured to facilitate retrieval of an offer 160.

18. A system as in claim 17, said retrieval tool 134 being configured to facilitate retrieval of an offer 160 in accordance a search request configured by a user.

19. A system as in claim 17, said retrieval tool 134 being configured to facilitate retrieval of an offer 160, said offer including parameters defined by a user.

20. A system as in claim 17, said retrieval tool 134 being configured to facilitate retrieval of an offer 160, said offer including only parameters defined by a user.

21. A system as in claim 1, said retrieval engine 130 being configured to facilitate generation of a report 138 describing offers contained within the repository 110.

22. A system as in claim 1, said retrieval engine 130 being configured to facilitate generation of a report 138 describing times an offer has been retrieved.

23. A system as in claim 1, said retrieval engine 130 being configured to facilitate modification of an offer in accordance with a predetermined set of rules.

24. The system of claim 1 wherein said offer details 164 include an offer identifier 165, an offer promotion identifier 166, an offer type 167, a description of qualifying offerees 168, and a definition of offer terms 169.

25. The system of claim 1 wherein said offer details 164 include a merchant name 170.

26. The system of claim 1 wherein said offer details 164 include a trademark identifying the target merchant or the target goods 171.

27. The system of claim 1 wherein said offer details 164 include merchant demographics 172.

28. The system of claim 1 wherein said offer details 164 include an offer category identifier 173.

29. The system of claim 1 wherein said offer details 164 include a merchant type identifier 174.

30. The system of claim 1 wherein said offer details 164 include a geographic location identifier 175.

31. The system of claim 1 wherein said offer details 164 include a target product or service identifier 176.

32. The system of claim 1 wherein said offer details 164 include a description of a term of the offer 177.

33. The system of claim 1 wherein said offer details 164 include a definition of the term for displaying the offer 178.

34. The system of claim 1 wherein said offer details 164 include key word(s) 179.

35. The system of claim 1 wherein said offer details 164 include SKU/UPC information 180.

36. The system of claim 1 wherein said offer details 164 include customer service telephone number 181.

37. A method of administering an incentive offer storage and retrieval process comprising the steps of:
providing a centralized repository 110, a maintenance engine 120 in communication with the centralized repository 110 for facilitating the maintenance of the repository 110, and a retrieval engine 130 in communication with the centralized repository 110 for facilitating the identification and retrieval of an offer 160, said centralized repository 110 being configured to store a plurality of offers 160;
said maintenance engine 120 performing a database maintenance process (step 320); and
said retrieval engine 130 retrieving offers 160 in conformance with a request 140 from a user 150.
